(19) United States
(12) Patent Application Publication
(10) Pub. No.: US 2026/0034662 A1
(43) Pub. Date: Feb. 5, 2026

(54) BOARD AND FASTENER PLACEMENT METHOD AND DEVICES

(71) Applicant: Greg McQuarrie, Coeur d'Alene, ID (US)

(72) Inventor: Greg McQuarrie, Coeur d'Alene, ID (US)

(21) Appl. No.: 18/788,742

(22) Filed: Jul. 30, 2024

(51) Int. Cl. B25H 7/00; E04G 21/18

(52) U.S. Cl. CPC B25H 7/00; E04G 21/1841

(57) ABSTRACT

A device may include a body configured to show a measurement between two boards having at least two openings and an attachment arm. A device may include the at least two openings configured to receive a measurement device wherein a first opening of the at least two openings receives the measurement device in a first horizontal orientation and a second opening of the at least two openings receives the measurement device in a second vertical orientation. A device may include the attachment arm, positioned orthogonal to the body and configured to attach the body to a support beam.

### FIELD OF THE INVENTION

The present invention generally relates to woodworking devices, and more particularly to measurement of deck and fence board placement.

### BACKGROUND

Currently, woodworking devices do not include the option to have a spacing tool coupled with a measurement device for the measurement of notch points for fasteners. For example, where a person is constructing a deck and wishes to measure the distance between two boards as well as the fastener location on the board to be placed, the person will likely need to use separate devices making the process long and tedious. Further, where a device offers a measurement feature, the device is constrained to a specific spacing or notch point pattern. However, each of these current solutions may result in an inefficient use of time and limitation to certain widths or fastener patterns.

As such, there is thus a need for addressing these and/or other issues associated with the prior art.

### SUMMARY

A method and devices are provided for the use of woodworking devices in the context of deck and fence construction. A woodworking device may comprise a body configured to measure the space between two boards having at least two openings and an attachment arm the at least two openings configured to receive a measurement device wherein a first opening of the at least two openings receives the measurement device in a first horizontal orientation and a second opening of the at least two openings receives the measurement device in a second vertical orientation, and the attachment arm, positioned orthogonal to the body and configured to attach the body to a support beam.

A measurement device, may comprise a body having a measurement arm, an attachment arm, and a stabilizing arm, the measurement arm comprised of at least one notch point, wherein the at least one notch point is configured to indicate a screw point for attaching a wood board to a support board, the attachment arm orthogonally connected to the measurement body configured to be placed upon a support beam, and the stabilizing arm perpendicular to the measurement arm for stabilizing the measurement device against an already placed board.

A method for measuring woodworking components, may comprise providing a measuring device configured with notch points, wherein each of the notch points are configured to indicate a screw point for attaching a wood board to a support board, and providing a woodworking device that may comprise, a body having at least two openings, wherein each of the at least two openings is configured to receive the measuring tool, and a first opening of the at least two openings is configured for a first horizontal orientation of the measuring tool, and a second opening of the at least two openings is configured for a second vertical orientation of the measuring tool, an attachment arm, positioned orthogonal to the body and configured to attach the body to a support beam, measuring the placement of the screw points on the wood board by inserting the measuring device through the first opening or the second opening.

### BRIEF DESCRIPTION OF THE DRAWINGS

FIG. 1 illustrates a measurement device to locate fastener placement, in accordance with one embodiment.

FIG. 2 illustrates a woodworking device which measures the space between boards and provides an opening for a measurement tool to be inserted, in accordance with one embodiment.

FIG. 3 illustrates a method for using the measurement device and the woodworking device in the context of deck or fence construction, in accordance with one embodiment.

FIG. 4 illustrates a woodworking device in the context of fence construction, in accordance with one embodiment.

FIG. 5 illustrates a woodworking device in the context of deck construction, in accordance with one embodiment.

FIG. 6 illustrates a measurement device in the context of deck construction, in accordance with one embodiment.

### DETAILED DESCRIPTION

Woodworking devices presently provide for assistance in either the context of deck construction or fence construction despite the techniques being similar in both contexts. For instance, a spacing tool used to determine the correct spacing for placing a deck board may have a woodworking device whereas the same device would not be applicable to fence construction because of the device's design limitations. As such, there is a need for woodworking devices and a method of using the devices in the context of both deck and fence construction.

Additionally, as disclosed herein, the method and devices provide for multiple permutations depending on the plane that is needed for the user. For example, when working on a fence, the user may use the devices in a vertical plane. Additionally, when working on a deck, the user may use the devices in a horizontal plane. Finally, because the construction industry is built on the ability to be efficient with the worker's time, there is a need for a method that maximizes the time spent when working on a deck or fence.

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Exemplary Embodiments

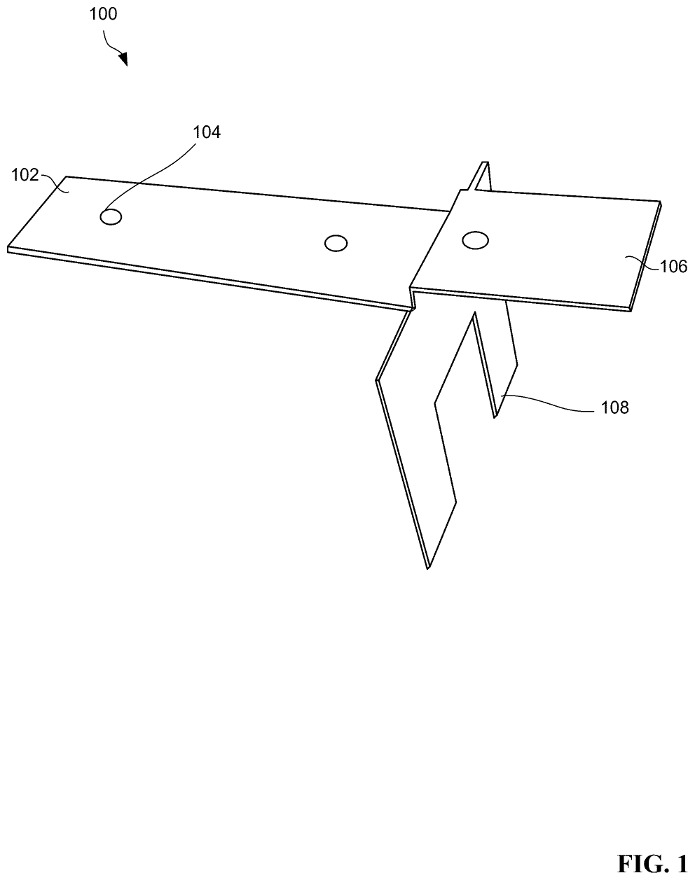

FIG. 1 illustrates a measurement device 100 for determining the placement of the fastener on a fence or deck board, in accordance with one embodiment. The measurement device 100 is used by placement on a fence or deck support beam and on top of a fence or deck board. For example, placement for the measurement device 100 for a deck board measurement is on a horizontal plane whereas placement for a fence board will be on a vertical plane relative to the support beams. Further, the measurement device 100 may be configured to measure different patterns or placements of the fasteners to the fence or deck board. In still another embodiment, the measurement device 100 may be configured to attach to different sizes of supports and be able to space the boards at different intervals to achieve the desire of the user.

As shown, the measurement device 100 is comprised of multiple parts for use measuring the fastener position and spacing between the fence or deck boards such as the measurement arm 102 that rests on top of a board. The measurement arm 102 may be configured to be a length that spans the width of the desired board to ensure correct measurement for placement of the fasteners. For instance, when working with a 1 in. by 5 in. board, the measurement arm 102 may be 5 in. wide to accommodate the proper measurement of the specific board. Further, the measurement arm 102 may be configured for any size of board desired, common examples may include 1×4, 1×5, 1×6, and 2×4 boards.

Additionally, the measurement arm 102 may contain a plurality of notch points 104 depending on the amount of fasteners that are to attach to the fence or deck board. The notch points 104 may show the user where fasteners may be placed on the fence or deck board dependent on the layout of the notch points 104. For instance, a user may prefer to have a measurement arm 102 contain two notch points 104 for a stable attachment of the fence or deck board to the support beam. Further, a user may prefer to have a measurement arm 102 contain four notch points 104 to provide for an even more secure attachment of the board to the support beam. Additionally, the notch points 104 may be configure to make a pattern such as two offset notches, three cascading notches, four notches forming a “U” shape, or others. The notch points 104 may also be configured for different types of fasteners such as screws, nails, or rivets and for different sizes of these fasteners. Further still, the notch points 104 may be configured for a marking device such as a pencil, pen, marker, or the like.

Further, attached to the measurement device 100 body perpendicular to the measurement arm 102 is a stabilization arm 106. The stabilization arm 106 may be configured to provide a stable placement by resting on a previously placed fence or deck board. The stabilization arm 106 may also have a notch point 104 for measurement of a first or last placed fastener placement. Further, the notch point 104 located on the stabilization arm 106 may also be used for aligning the measurement device 100 such that notch points 104 on the measurement arm 102 are in the same line as the notch points on a previously fastened board.

In addition, the measurement device 100 comprises an attachment arm 108. The attachment arm 108 may be configured to attach the measurement device 100 onto a support beam of a fence or deck. The width of the opening wherein the support beam fits may be a number of different widths depending on the user's need. For instance, the widths may fit 1×4, 1×5, 1×6, 2×4 boards, or further needed measurements. The attachment arm 108 is positioned in an orthogonal position in comparison the measurement arm 102.

The attachment arm 108 may also be a plurality of thicknesses to act as a spacing tool with respect to the placement of the boards adjacent to each other. For instance, where a user requires a spacing between each board of ¼ inch, the thickness of the attachment arm 108 may be ¼ inch.

A measurement device may comprise a body having a measurement arm, an attachment arm, and a stabilizing arm. Further, the measurement device may comprise a measurement arm comprised of at least one notch point, wherein the at least one notch point is configured to indicate a screw point for attaching a wood board to a support board. Additionally, the measurement device may comprise an attachment arm orthogonally connected to the measurement body configured to be placed upon a support beam and a stabilizing arm perpendicular to the measurement arm for stabilizing the measurement device against an already placed board.

A method for measuring woodworking components may comprise providing a measuring device configured with notch points, wherein each of the notch points are configured to indicate a screw point for attaching a wood board to a support board and providing a first device comprising a body having at least two openings, wherein each of the at least two openings is configured to receive the measuring tool, and a first opening of the at least two openings is configured for a first orientation of the measuring tool, and a second opening of the at least two openings is configured for a second orientation of the measuring tool. Further, the method may comprise an attachment arm, positioned orthogonal to the body and configured to attach the body to a support beam.

In the decking industry, common issues include uneven spacing of fasteners along deck boards, the lack of a useful solution to ensuring even spacing, and a tool that allows the user to measure the correct spacing at an efficient rate for expedient construction. The present disclosure solves this issues by providing a tool capable of efficiently measuring the spacing of fastening screws, is configured to work together with other measurement devices, and may be manufactured to any specific spacing requirement needed by the user. Further, such solutions are an improvement to existing designs and tools. In fact, the present woodworking device would optimize time efficiency of the user in that two separate discrete tools can be integrated into a single tool. Additionally, uniformity in screw placement may be improved such that a visual benefit to the screws may be displayed in the resulting screw pattern on the wood boards.

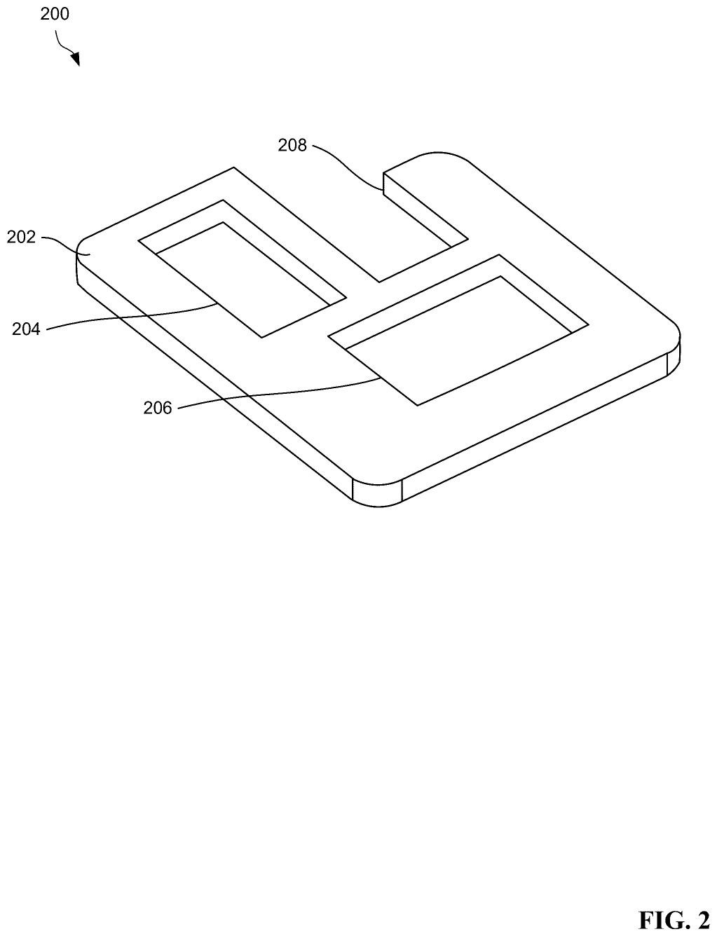

FIG. 2 illustrates a woodworking device 200 for measuring the space between a placed fence or deck board and a board to be placed, in accordance with one embodiment. As an option, the woodworking device 200 may be implemented in the context of any one or more of the embodiments set forth in any previous and/or subsequent figure(s) and/or description thereof. Of course, however, the woodworking device 200 may be implemented in the context of any desired environment. Further, the aforementioned definitions may equally apply to the description below.

The woodworking device 200 may be configured to show a measurement the width between two fence or deck boards in accordance with the user's desired width. For instance, the width of the woodworking device 200 may be ¼ inch where the user desires ¼ inch between each placed board. This gives the advantage of an aesthetic that is uniform across the entire fence of deck regarding the placement of each board. The woodworking device 200 also provides the user with the ability to rely on the device for the correct measurement for the placement of each board ensuring the uniformity of the boards.

The woodworking device 200 has a body 202 that may be made of a plurality of materials. For instance, the body 202 may be made of a polycarbonate plastic printed to provide a measurement the user prefers given a specific build of a fence or deck. Further, the body may be made of a metallic substance where the woodworking device 200 has a more standard measurement used across the industry. This may make the woodworking device 200 more dependable and sustainable where it is used on a frequent basis. Additionally, the body 202 may be made of different colored plastics or metals to make the woodworking device 200 stand out against the colors of the fence or deck for easy retrieval or be easily distinguishable for accurate placement against a board.

The body 202 has at least two openings 204 and 206. The openings 204 and 206 may be configured such that one may be used in a horizontal plane and the other may be used in a vertical plane. For example, when working on a deck, a user may use the woodworking device 200 in a horizontal plane thus using the opening 206 for the insertion of a measurement device. Likewise, when working on a fence, a user may use the woodworking device 200 in a vertical plane thus using the opening 204 for the insertion of a measurement device. Furthermore, the openings 204 and 206 may be used as a handle when the woodworking device 200 is in use. A user may include a third opening to provide as an insertion point for a second measurement device, a handle, or other use needed by a user. These openings in combination provide the user with efficient access to measurement points while setting the deck board.

The woodworking device 200 also has an attachment arm 208. The attachment arm 208 is positioned in an orthogonal manner to the rest of the body 202 such that it may be attached to a support beam of a fence or deck. The attachment arm 208 may be designed to hook onto the support beam, rest on the support beam, or another attachment method similar to those described.

A woodworking device may comprise a body configured to measure the space between two boards having at least two openings and an attachment arm. The woodworking device may further comprise at least two openings configured to receive a measurement device wherein a first opening of the at least two openings receives the measurement device in a first horizontal orientation and a second opening of the at least two openings receives the measurement device in a second vertical orientation. Further still, the woodworking device may comprise an attachment arm, positioned orthogonal to the body and configured to attach the body to a support beam.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

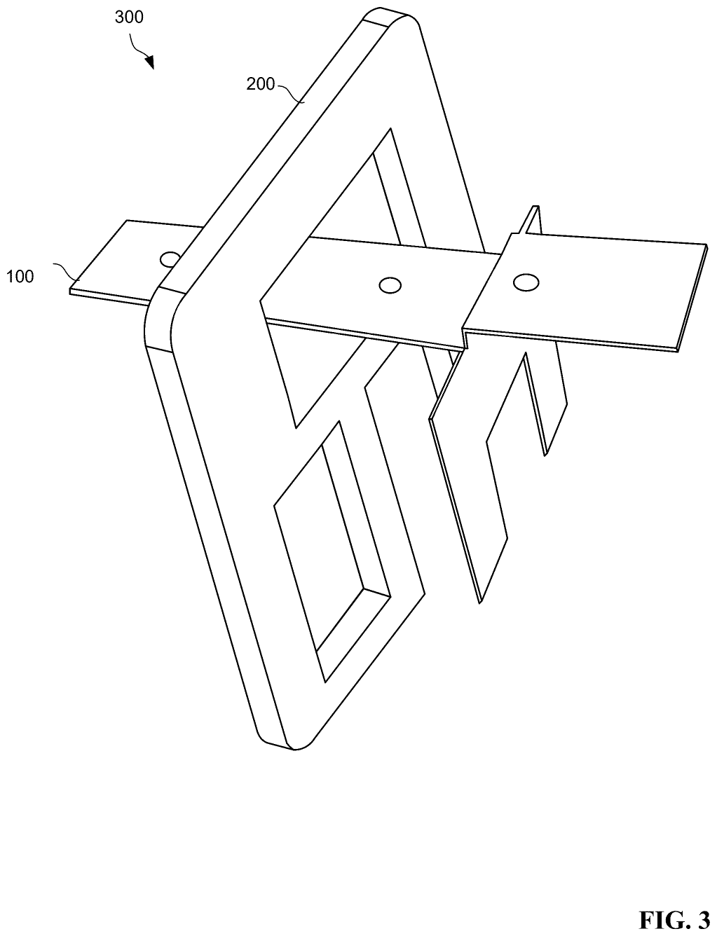

FIG. 3 illustrates a method 300 for use of the measurement device 100 in combination with the woodworking device 200, in accordance with one embodiment. As an option, the method 300 may be implemented in the context of any one or more of the embodiments set forth in any previous and/or subsequent figure(s) and/or description thereof. Of course, however, the method 300 may be implemented in the context of any desired environment. Further, the aforementioned definitions may equally apply to the description below.

The method displayed in FIG. 300 shows how the devices may be used in combination to measure the correct placement of a deck board. The woodworking device 200 and the measurement device 100 may be placed on a deck support beam using the attachment arm 208 and the attachment arm 108 on the respective devices. The woodworking device 200 measures the gap between the existing deck board and the board to be placed while the measurement device 100 measures the placement of the notch points 104 to secure the board to the support beam. The measurement device 100 is inserted through the vertically placed woodworking device 200 using the opening 206. The openings 204 or 206 may then be used as a handle to place the woodworking device 200 on the support beam or remove the woodworking device 200 from the support beam.

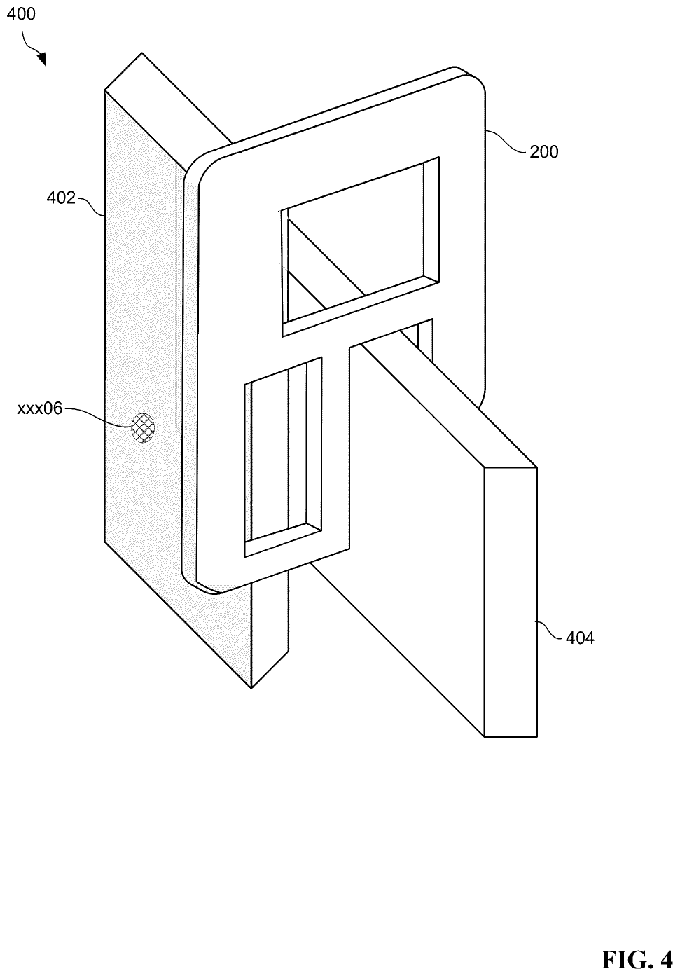

FIG. 4 illustrates a method 400 for implementing the woodworking device 200 in the context of fence construction, in accordance with one embodiment. As an option, the method 400 may be implemented in the context of any one or more of the embodiments set forth in any previous and/or subsequent figure(s) and/or description thereof. Of course, however, the method 400 may be implemented in the context of any desired environment. Further, the aforementioned definitions may equally apply to the description below.

As shown, the woodworking device 200 is used in a vertical plane for measurement of the fence boards placement along the support beams. The woodworking device comprises two openings 204 and 206. The horizontal opening 204 providing access to the front of the fence boards for insertion of a measurement device 100 to determine the location of fasteners needed to secure the fence board to the support beam. The vertical 206 opening provides an easy handle for the user to move the woodworking device 200 from place to place during construction. Overall, the woodworking device 200 provides the user with an expedient construction experience because the width of the woodworking device 200 is configured to the spacing desired between two fence boards. This feature allows the user to rely on the device for measurement of the spacing instead of continually ensuring the spacing is correct using a tape measure, for instance.

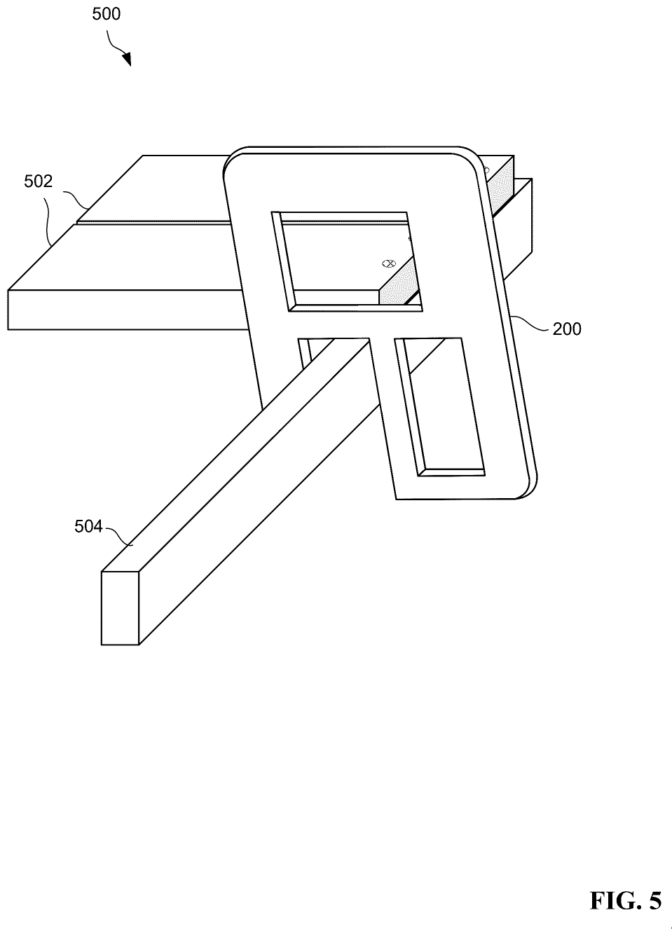

FIG. 5 illustrates a method 500 for implementing the woodworking device 200 in the context of deck construction, in accordance with one embodiment. As an option, the method 500 may be implemented in the context of any one or more of the embodiments set forth in any previous and/or subsequent figure(s) and/or description thereof. Of course, however, the method 500 may be implemented in the context of any desired environment. Further, the aforementioned definitions may equally apply to the description below.

As shown, the woodworking device 200 is used in a horizontal plane for measurement of the deck boards placement along the support beams. The woodworking device comprises two openings 204 and 206. The vertical opening 206 providing access to the front of the deck boards for insertion of a measurement device 100 to determine the location of fasteners needed to secure the deck board to the support beam. The horizontal opening 204 provides an easy handle for the user to move the woodworking device 200 from place to place during construction. Overall, the woodworking device 200 provides the user with an expedient construction experience because the width of the woodworking device 200 is configured to the spacing desired between two deck boards. This feature allows the user to rely on the device for measurement of the spacing instead of continually ensuring the spacing is correct using a tape measure, for instance.

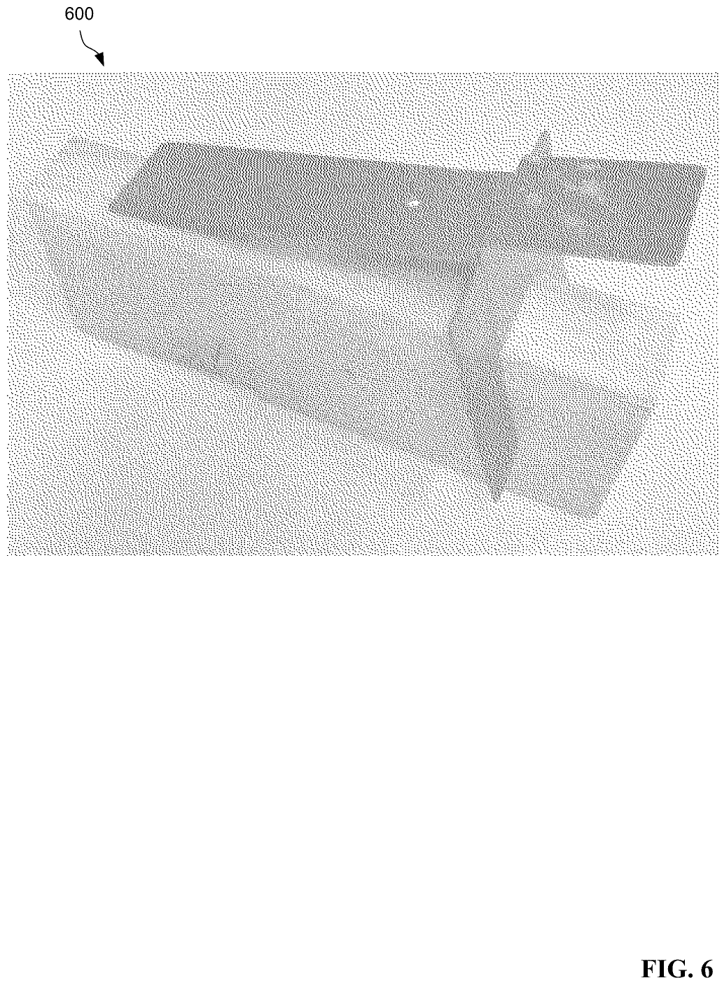

FIG. 6 illustrates a method 600 for implementing the measurement device 100, in accordance with one embodiment. As an option, the method 600 may be implemented in the context of any one or more of the embodiments set forth in any previous and/or subsequent figure(s) and/or description thereof. Of course, however, the method 600 may be implemented in the context of any desired environment. Further, the aforementioned definitions may equally apply to the description below.

As shown, the measurement device 100 is used in a horizontal plane attaching to a support beam using the attachment arm 108. Placing the measurement device 100 on the support beam allows for stabilization of the device when in use. Further, when a deck board is placed underneath the measurement arm 102, the measurement device 100 provides for evenly spaced fastener placement using the device's notch points 104. The measurement device 100 is configured to provide an efficient construction process for the user because of the predetermined spacing of the fasteners. Finally, the measurement device 100 is configured to be used with a woodworking device 200 to provide a seamless work flow as the user moves from deck board to deck board.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A woodworking device, comprising:
a body configured to show a measurement between two boards having at least two openings and an attachment arm;
the at least two openings configured to receive a measurement device wherein a first opening of the at least two openings receives the measurement device in a first horizontal orientation and a second opening of the at least two openings receives the measurement device in a second vertical orientation; and
the attachment arm, positioned orthogonal to the body and configured to attach the body to a support beam.

2. The device of claim 1, wherein the measurement apparatus is configured to determine spacing of fasteners on a board joining the board to the support beam.

3. The device of claim 1, wherein the body is comprised of a metal material or polymer material.

4. The device of claim 1, wherein the body is configured to rest on the support beam in a first horizontal position and a second vertical position.

5. The device of claim 1, wherein the support beam comprises a joist or a standard.

6. The device of claim 1, wherein the body is a width between ⅛ to ¼ inches.

7. A measurement device, comprising:
a body having a measurement arm, an attachment arm, and a stabilizing arm;
the measurement arm comprised of at least one notch point, wherein the at least one notch point is configured to indicate a screw point for attaching a wood board to a support board;
the attachment arm orthogonally connected to the measurement body configured to be placed upon a support beam; and
the stabilizing arm perpendicular to the measurement arm for stabilizing the measurement device against an already placed board.

8. The device of claim 7, wherein the measurement device is configured such that the measurement arm has a length of 5 and ¼ inches.

9. The device of claim 7, wherein the measurement device is configured such that the stabilizing arm has one or more notch points.

10. The device of claim 7, wherein the measurement device is configured such that the body is made of a polycarbonate plastic or metal.

11. The device of claim 7, wherein the measurement device is configured such that the stabilizing arm has an opening with a width of two inches.

12. The device of claim 7, wherein the measurement device is configured such that stabilizing arm is positioned slightly higher than the measurement arm.

13. A method for measuring woodworking components, comprising:
providing a measuring device configured with notch points, wherein each of the notch points are configured to indicate a screw point for attaching a wood board to a support board;
providing a woodworking device comprising:
a body having at least two openings, wherein each of the at least two openings is configured to receive the measuring tool, and a first opening of the at least two openings is configured for a first horizontal orientation of the measuring tool, and a second opening of the at least two openings is configured for a second vertical orientation of the measuring tool;
an attachment arm, positioned orthogonal to the body and configured to attach the body to a support beam; and
measuring the placement of the screw points on the wood board by inserting the measuring device through the first opening or the second opening.

14. The method of claim 13, wherein the measuring device is inserted into the first opening in the first horizontal orientation of the woodworking device.

15. The method of claim 13, wherein the measuring device is inserted into the second opening in the second vertical orientation of the woodworking device.

16. The method of claim 13, wherein both the woodworking device and the measuring device attach to the support board of a deck or fence.

17. The method of claim 13, wherein the measuring device has one or more notch points for the placement of the screw points.

18. The method of claim 13, wherein the measuring device is made of a polycarbonate plastic or metal.

19. The method of claim 13, wherein the woodworking device is made of a polycarbonate plastic or metal.

20. The method of claim 13, wherein the woodworking device and the measuring device have a combined width of ¼ inch.
